(19) United States
(12) Patent Application Publication
(10) Pub. No.: US 2012/0121366 A1
(43) Pub. Date: May 17, 2012

(54) SUSPENDING MEMBER BREAKAGE PREVENTING MECHANISM IN A SPARE WHEEL HOLDING APPARATUS

(75) Inventor: Akira OGAWA, Inazawa-shi (JP)

(73) Assignee: SANKOKIKI KABUSHIKI KAISHA, Aichi-ken (JP)

(21) Appl. No.: 13/283,986

(22) Filed: Oct. 28, 2011

(30) Foreign Application Priority Data
Nov. 17, 2010 (JP) 2010-257100

(51) Int. Cl. B62D 43/04; B66D 1/00

(52) U.S. Cl. 414/463; 254/323

(57) ABSTRACT

A spare wheel holding apparatus includes a device for winding up a spare wheel with a suspending member. The device includes a rotation restricting plate and a rotation restricting pin having a projecting pin portion. When a winding-off force is applied to the suspending member, the rotation restricting plate abuts on the projecting pin portion, thereby stopping winding-off of the suspending member. A suspending member breakage preventing mechanism also uses the rotation restricting pin as a safety pin. If the winding-off force is larger than that in normal, the projecting pin portion is broken at a root portion, the suspending member is wound off, thereby preventing breakage. The root portion has a smaller thickness than a tip end portion of the projecting pin portion.

### CROSS-REFERENCE TO RELATED APPLICATIONS

This application claims the priority under 35 U.S.C. 119 to Japanese Patent Application No. 2010-257100 filed on Nov. 17, 2010, which is incorporated herein by reference in its entirety.

### BACKGROUND OF THE INVENTION

1. Field of the Invention

The present invention relates to a mechanism of preventing breakage of a member for suspending a spare wheel in an apparatus for holding a spare wheel to a motor vehicle.

2. Description of the Related Art

[Spare Wheel Holding Apparatus]

A spare wheel holding apparatus is provided with a wheel support member for supporting a spare wheel, and a winding device for winding up the wheel support member. The winding device is provided with a suspending member. The suspending member is connected to the wheel support member. The suspending member is typically a chain or a wire rope. A transportation vehicle or a passenger car is equipped with the winding device of the spare wheel holding apparatus on its car body. The wheel support member is suspended from the winding device by the suspending member. The spare wheel supported by the wheel support member is wound up by the winding device and held to the lower side of the car body.

In the case that the spare wheel is held to the lower side of the car body, which is different from the case that the spare wheel is stored in the car body, when the motor vehicle collides, large forces may be applied to the spare wheel and a large winding-off force may be applied to the suspending member of the winding device. When the large winding-off force is applied to the suspending member of the winding device, since the winding device has large reduction ratio, the suspending member is not wound off and is broken. If the suspending member is broken, the spare wheel and the wheel support member are separated from the car body and run with inertia on a road, which is dangerous.

[Spare Wheel Holding Apparatus with Suspending Member Breakage Preventing Mechanism]

As disclosed in U.S. Pat. No. 6,409,454 B (“Yamamoto”), for a spare wheel holding apparatus, a mechanism for preventing a suspending member of a winding device from being broken when a large winding-off force is applied to the suspending member has been invented.

In this spare wheel holding apparatus with a suspending member breakage preventing mechanism, a winding device is provided with a case, a main shaft supported on the case in a bearing state, a winding drum rotatably fitted to the main shaft, a suspending member being wound on the winding drum, and a planetary gear mechanism having large reduction ratio. The planetary gear mechanism includes an internal gear of a sun gear and an external gear of a planet gear. The internal gear is concentrically provided on the side surface of the winding drum, an eccentric cam is provided on the main shaft, the external gear is rotatably fitted to the eccentric cam, and the internal gear and the external gear in eccentricity are meshed in relation to the inside and the outside. A rotation restricting plate is provided to the side surface of the external gear, and a rotation restricting pin is provided on the case. The rotation restricting plate abuts on the rotation restricting pin so that the rotation of the external gear on its own axis is restricted. During winding-up rotation and winding-off rotation of the main shaft, the rotation restricting plate and the external gear revolve around the center axis of the internal gear, and the internal gear and the winding drum are rotated in reduction.

When a winding-off force is applied to the suspending member, the rotation restricting plate abuts on the rotation restricting pin to stop the reverse rotation of the winding drum and the winding-off of the suspending member. The rotation restricting pin has a thickness and a strength where the rotation restricting pin breaks when the winding-off force applied to the suspending member is larger than that in normal use. The rotation restricting pin also serves as a safety pin. When the rotation restricting pin serving also as the safety pin is broken, the winding drum rotates reversely to wind off the suspending member, thereby preventing the suspending member from being broken.

In the rotation restricting pin serving also as the safety pin, its failure strength can be set to a desired value by adjusting the thickness. The setting of the failure strength is easy. The winding-off force of the suspending member for the rotation restricting pin serving also as the safety pin to be broken is scarcely varied by the eccentric direction or the position of the center axis of the eccentric cam and becomes substantially constant value.

### BRIEF SUMMARY OF THE INVENTION

### Problems

In a spare wheel holding apparatus with a suspending member breakage preventing mechanism such as described above, the rotation restricting plate generates friction against the rotation restricting pin during winding-up rotation and winding-off rotation of the main shaft. The rotation restricting pin is worn by the friction of the rotation restricting plate during revolution. When the winding-up rotation and winding-off rotation of the main shaft are repeated, in the rotation restricting pin serving also as the safety pin, the circumferential surface is worn, the thickness is decreased and the failure strength is reduced. Then, even if the winding-off force applied to the suspending member is smaller than a preset value, the rotation restricting pin serving also as the safety pin is broken. The rotation restricting pin serving also as the safety pin can unexpectedly break, the suspending member is wound off, and consequently the wheel support member and the spare wheel thereon are dropped off. Further, when the rotation restricting pin serving also as the safety pin is broken, it is troublesome to replace the same with a new one.

It is desired to solve such an inconvenience. It is also desired to keep the advantage that the failure strength of the rotation restricting pin serving also as the safety pin is easy to set, and the advantage that the winding-off force of the suspending member, which breaks the rotation restricting pin serving also as the safety pin, is scarcely varied by the position of the center axis of the eccentric cam.

### Ideas

The relationship between the rotation restricting pin serving also as the safety pin and the rotation restricting plate is as follows, from detailed examination. The rotation restricting pin serving also as the safety pin has one end fixed to the case and the other end projecting into the case. The projecting pin portion is in contact with the rotation restricting plate at a circumferential surface, the circumferential surface is rubbed by the rotation restricting plate during revolution to be worn, and the thickness is reduced. Further, the projecting pin portion is subject to a lateral force from the rotation restricting plate, and receives a bending moment. The projecting pin portion becomes like a cantilever subject to a lateral load. That is, in the projecting pin portion, the bending moment becomes largest at the root portion, and the root portion is a breakage location. The failure strength is determined according to a shape and size of a cross section of the root portion. Therefore, when the root portion at the breakage location is reduced in diameter due to the frictional wear caused by contact with the rotation restricting plate, the projecting pin portion of the rotation restricting pin serving also as the safety pin is broken even if the winding-off force applied to the suspending member is smaller than the preset value.

Therefore, the projecting pin portion of the rotation restricting pin serving also as the safety pin, which is configured to prevent the root portion that determines the failure strength from being reduced in diameter due to frictional wear caused by the rotation restricting plate, has been devised. In the projecting pin portion, the root portion is set narrower than the tip end portion. This makes the root portion out of contact with the rotation restricting plate, and the root portion is not rubbed by the rotation restricting plate. The tip end portion comes in contact with the rotation restricting plate to be rubbed. The root portion constitutes a frictionless portion that is not rubbed by the rotation restricting plate, and also constitutes a strength-determining portion that determines the failure strength. That is, the root portion constitutes a frictionless failure strength-determining portion. The tip end portion constitutes a frictional portion.

### Means of Solving the Problems

1. In a suspending member breakage preventing mechanism in a spare wheel holding apparatus, the spare wheel holding apparatus includes a wheel support member which supports a spare wheel, and a winding device which lifts up the wheel support member in a winding-up manner. The winding device includes a case, a main shaft supported by the case in a bearing state, a winding drum rotatably fitted on the main shaft, a suspending member being wound on the winding drum, the suspending member being connected with the wheel support member, and a planetary gear mechanism having a large reduction ratio. The planetary gear mechanism includes an internal gear provided concentrically to a side surface of the winding drum, an eccentric cam provided to the main shaft, an external gear rotatably fitted on the eccentric cam, the external gear being meshed with the internal gear, a rotation restricting plate provided to a side surface of the external gear, and a rotation restricting pin provided to the case, where the rotation restricting plate abuts on the rotation restricting pin to restrict axial rotation of the external gear, and when a winding-off force is applied to the suspending member, the rotation restricting plate abuts on the rotation restricting pin to stop reverse rotation of the winding drum. The suspending member breakage preventing mechanism also uses the rotation restricting pin as a safety pin, and the rotation restricting pin has a strength set so as to break when the winding-off force applied to the suspending member is larger than that in normal use. When the rotation restricting pin serving also as the safety pin is broken, the winding drum is rotated reversely and the suspending member is wound off. The rotation restricting pin serving also as the safety pin has one end fixed to the case and the other end projecting into the case, the projecting pin portion is rubbed by contact with the rotation restricting plate, is subjected to a lateral force from the rotation restricting plate, and has a root portion set as a breakage location. The root portion is narrower or thinner than a tip end portion of the projecting pin portion, the tip end portion constitutes a frictional portion which is rubbed by contact with the rotation restricting plate, and the root portion constitutes a frictionless failure strength-determining portion which is not rubbed by the rotation restricting plate.

2. In the suspending member breakage preventing mechanism according to the aspect 1 described above, the root portion is concentric with and smaller in diameter than the tip end portion.

3. In the suspending member breakage preventing mechanism according to the aspect 1 or 2 described above, the projecting pin portion is disposed in a direction parallel to the main shaft. The rotation restricting plate is provided with a groove extending in a direction from a circumferential surface toward the eccentric cam. The projecting pin portion is disposed in the groove. A circumferential surface of the frictional portion comes in contact with a side surface of the groove.

4. In the suspending member breakage preventing mechanism according to the aspects 1, 2, or 3 described above, a distance between a contact point of the rotation restricting pin with the rotation restricting plate occurring when a winding-off force is applied to the suspending member and a rotation center axis of the main shaft becomes substantially constant value irrespective of the position of the eccentric cam.

5. In the suspending member breakage preventing mechanism according to any one of the aspects 1 to 4 described above, the winding drum becomes able to make one or more reverse rotations when the projecting pin portion is broken off at the root portion.

6. In the spare wheel holding apparatus according to any one of the aspects 1 to 5, the case of the winding device is mounted on a car body of a motor vehicle, and the spare wheel supported on the wheel support member is wound up and held to a lower side of the car body.

### BRIEF DESCRIPTION OF THE SEVERAL VIEWS OF THE DRAWING

FIG. 1 is a left side view of a spare wheel holding apparatus with a suspending member breakage preventing mechanism in a first embodiment of the present invention, where a winding device is cut in line I-I in FIG. 2;

FIG. 2 is a front view of the spare wheel holding apparatus, where the winding device is cut in line II-II in FIG. 1;

FIG. 3 is a sectional view of the winding device cut in line in FIG. 2;

FIGS. 4(a) and 4(b) are enlarged views of a rotation restricting pin serving also as a safety pin of the winding device, FIG. 4(a) being a rear view thereof, FIG. 4(b) being a side view thereof;

FIG. 5 is a schematic side view of the state that the spare wheel holding apparatus is mounted on a car body of a motor vehicle;

FIG. 6 is an explanatory diagram showing relationship between a distance between the abutting point of the rotation restricting plate on the rotation restricting pin serving also as the safety pin and the rotation center axis of the main shaft, and the center-axis position of the eccentric cam, when the winding-off force is applied to the suspending member in the winding device;

FIG. 7 is a partially enlarged front view of a winding device of a spare wheel holding apparatus with a suspending member breakage preventing mechanism in a second embodiment of the present invention, where a similar sectional view to FIG. 2 is shown; and

FIG. 8 is a partially enlarged plan view of the winding device, where a similar sectional view to FIG. 3 is shown.

### DETAILED DESCRIPTION OF THE INVENTION

### First Embodiment

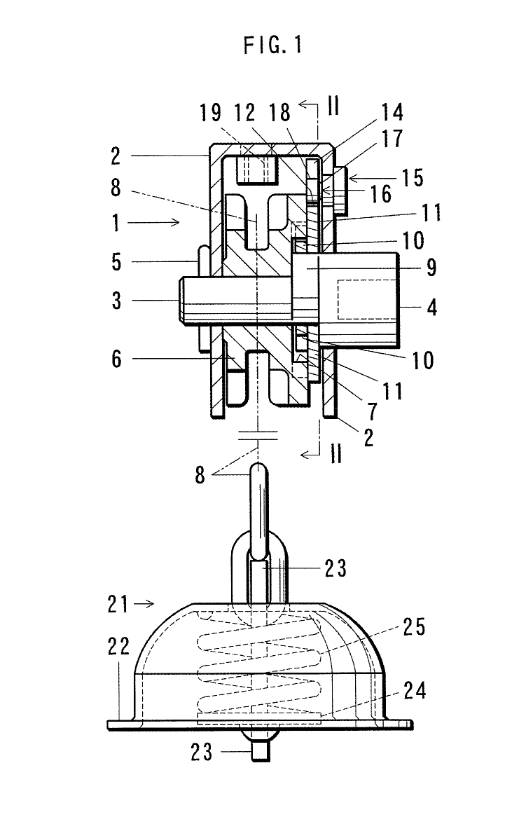

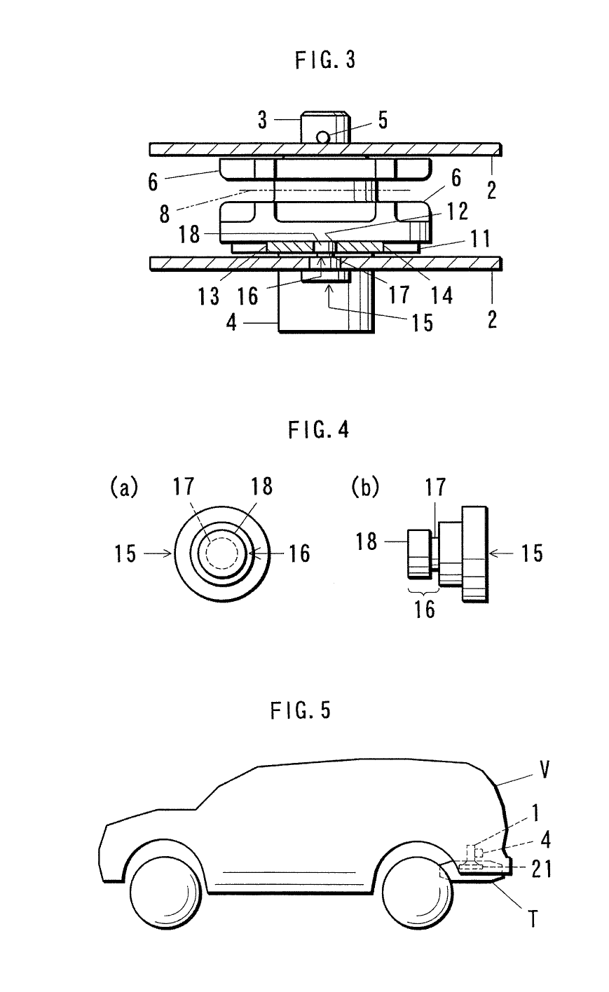

### See FIGS. 1 to 6

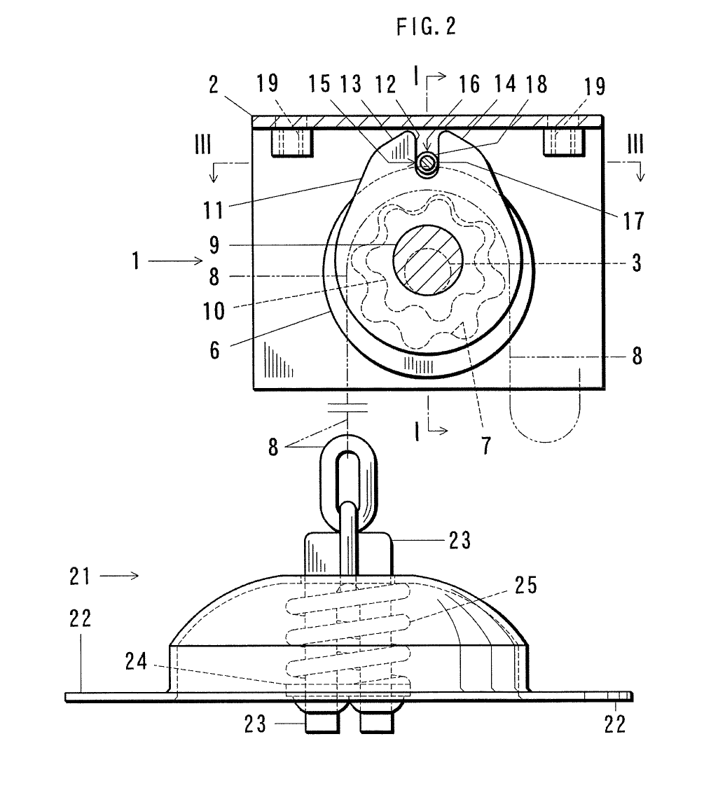

A spare wheel holding apparatus of this embodiment, as shown in FIG. 1 and FIG. 2, is provided with a wheel support member 21 which supports a spare wheel, and a winding device 1 which winds up the wheel support member 21. A center part of the wheel support member 21 is connected to a falling end of a suspending member 8 of the winding device 1.

The winding device 1, as shown in FIG. 1 to FIG. 3, is provided with a case 2 having a portal-shaped vertical cross section. The case 2 supports a main shaft 3 having a circular cross section in a bearing state, the main shaft 3 penetrating a front side plate and a rear side plate of the case 2 in the front-rear direction. The main shaft 3 has a front end portion formed in a concentric larger-diameter mouthpiece 4. The mouthpiece 4 has a rear end portion penetrating the front side plate of the case 2 to be supported by the case 2 in a bearing state, and has a front end portion whose large part projects from the front side of the case 2. A rear end of the main shaft 3 projects from the rear side of the case 2, and is provided with a slipping-out preventing pin 5. When the main shaft 3 is rotated, a rotating tool (not shown) is connected to the mouthpiece 4 and is rotated.

A winding drum 6 of a chain wheel is rotatably fitted to a portion of the main shaft 3 positioned inside the case 2 in concentric state. The winding drum 6 is disposed inside the case 2. A suspending member 8 of a chain is hung and wound on a chain groove on the outer circumference of the winding drum 6. A right end of the suspending member 8 is fixed to the right lower end of the front side plate of the case 2. A left end of the suspending member 8 is hung down under the case 2.

The winding device 1 is provided with a planetary gear mechanism having large reduction ratio. In the planetary gear mechanism, as shown in FIG. 1 and FIG. 2, an internal gear 7 is formed integrally and concentrically at a front side surface of the winding drum 6. In the main shaft 3, a portion between the portion fitted with the winding drum 6 and the mouthpiece 4 is formed as an eccentric cam 9 having a circular cross section. The eccentric cam 9 has a diameter larger than the main shaft 3 and smaller than the mouthpiece 4, and has a center axis parallel to the center axis of the main shaft 3 and slightly separated from the center axis of the main shaft 3. An external gear 10 is concentrically rotatably fitted to the eccentric cam 9. The external gear 10 has less teeth than the internal gear 7. The internal gear 7 and the external gear 10 are eccentric to each other like a relationship between the main shaft 3 and the eccentric cam 9, and are meshed in relation to the inside and the outside. The internal gear 7 is a sun gear. The external gear 10 is a planetary gear.

A rotation restricting plate 11 is rotatably fitted to the eccentric cam 9. The rotation restricting plate 11 is fixed to a front side surface of the external gear 10 so as to face the front side plate of the case 2. The external gear 10 and the rotation restricting plate 11 are arranged in parallel to each other within the case 2, and integrated with each other. The rotation restricting plate 11 has a larger diameter than a dedendum circle of the internal gear 7, and is held between a front side surface of the internal gear 7 and the front side surface of the winding drum 6, and a rear end surface of the mouthpiece 4. The rotation restricting plate 11 has an upper end extended upward, and a groove 12 is formed in a tip end of the upper end. The groove 12 is longitudinal and is extended downward from a circumferential surface of the tip end of the rotation restricting plate 11 toward the center of the eccentric cam 9 with a uniform width. The tip end of the upper end of the rotation restricting plate 11 has a bifurcated shape composed of a left side projection 13 and a right side projection 14 on left and right sides of the groove 12, respectively.

In the front side plate of the case 2, as shown in FIG. 1 to FIG. 3, a rotation restricting pin 15 having a circular cross section penetrates and is fixed. The rotation restricting pin 15, which has a head portion, has one end fixed to the front side plate of the case 2 on the side of the head portion, and the other end projecting into the case 2 on the side of a tip end. The projecting pin portion 16 projects rearward in parallel with the main shaft 3, and is inserted into the groove 12 so as to penetrate the rotation restricting plate 11. When the rotation restricting plate 11 forces to rotate clockwise, in FIG. 2, a left side face of the groove 12 abuts on a circumferential surface of the projecting pin portion 16. On the other hand, when the rotation restricting plate 11 forces to rotate counterclockwise, in FIG. 2, a right side face of the groove 12 abuts on the circumferential surface of the projecting pin portion 16.

The left side face or the right side face of the groove 12, the left side projection 13 or the right side projection 14 of the rotation restricting plate 11 abuts on the projecting pin portion 16 of the rotation restricting pin 15, so that axial rotations of the rotation restricting plate 11 and the external gear 10 are restricted. At a winding-up rotation time or a normal rotation time of the main shaft 3, the rotation restricting plate 11 and the external gear 10 revolve around the center axis of the internal gear 7 while their axial rotations are restricted, and the internal gear 7 and the winding drum 6 rotate in reduction. At a winding-off rotation time or a reverse rotation time of the main shaft 3, also, the rotation restricting plate 11 and the external gear 10 revolve around the center axis of the internal gear 7 while their axial rotations are restricted, and the internal gear 7 and the winding drum 6 rotate in reduction. When the rotation restricting plate 11 revolves while its axial rotation is restricted, the left side face or the right side face of the groove 12, the left side projection 13 or the right side projection 14 of the rotation restricting plate 11 rubs the circumferential surface of the projecting pin portion 16. The projecting pin portion 16 rubs the rotation restricting plate 11.

The spare wheel holding apparatus is provided with a suspending member breakage preventing mechanism. When a downward winding-off force is applied to a left end of the suspending member 8, the right side face of the groove 12, the right side projection 14 of the rotation restricting plate 11 abuts on the projecting pin portion 16 of the rotation restricting pin 15, thereby stopping reverse rotation of the winding drum 6 and winding-off of the suspending member 8. The projecting pin portion 16 is subjected to a lateral force from the right side face of the groove 12, the right side projection 14 of the rotation restricting plate 11. And a bending moment acts on the projecting pin portion 16. This bending moment becomes largest at a root portion 17. The projecting pin portion 16 is set so as to have a thickness and a strength where the projecting pin portion 16 is broken when the winding-off force applied to the suspending member 8 is larger than the winding-off force in normal use. The rotation restricting pin 15 also serves as a safety pin. When the rotation restricting pin 15 serving also as the safety pin is broken, the winding drum 6 rotates reversely, and the suspending member 8 is wound off. The suspending member 8 is prevented from being broken.

In the projecting pin portion 16 of the rotation restricting pin 15 serving also as the safety pin, as shown in FIG. 4, the root portion 17 is narrower or thinner than a tip end portion 18. The root portion 17 is set smaller in diameter than the tip end portion 18, and is set concentric with the tip end portion 18. When the projecting pin portion 16 is broken, the root portion 17 results as the location of the breakage without fail. The failure strength of the projecting pin portion 16 depends on the thickness and strength of the root portion 17. The root portion 17 constitutes a failure strength-determining portion. When the failure strength is adjusted, the thickness, i.e., the diameter of the root portion is increased or decreased. The tip end portion 18 constitutes a frictional portion which is rubbed by contact with the rotation restricting plate 11. The rotation restricting plate 11 does not come in contact with the root portion 17 having a diameter concentric with and smaller than the frictional portion 18. The root portion 17 is not brought into contact with the rotation restricting plate 11, and is not rubbed by the rotation restricting plate 11. That is, the root portion 17 constitutes a frictionless failure strength-determining portion which is not rubbed by the rotation restricting plate 11. In the projecting pin portion 16, the failure strength-determining portion 17 is not rubbed by the rotation restricting plate 11, and is not worn frictionally to be reduced in diameter. The predetermined failure strength is not reduced. The rotation restricting pin 15 is not unexpectedly broken.

The case 2 has a top plate provided with mounting bolt holes 19 positioned on the right and left.

In the wheel support member 21, as shown in FIG. 1 and FIG. 2, a center part of a support plate 22 is curved upward in a dome shape. The dome-shaped center part of the support plate 22 is adapted to be fitted to a hub hole of the spare wheel, and a peripheral part of the support plate 22 is adapted to support a peripheral part of the hub hole of the spare wheel. At the dome-shaped center part of the support plate 22, a suspending piece 23 is penetrated in a vertical direction. A receptacle piece 24 is fixed to the lower end of the suspending piece 23. A coil spring 24 penetrates the suspending piece 23, and is fitted between the receptacle piece 24 and the dome-shaped center portion of the support plate 22. The hanging left end of the suspending member 8 of the winding device 1 is connected to the upper end of the suspending piece 23.

When the main shaft 3 of the winding device 1 is rotated to wind up, the winding drum 6 is rotated in reduction clockwise, in the same direction as the main shaft 3. The left end of the suspending member 8 and the wheel support member 21 are lifted, and the spare wheel on the wheel support member 21 is lifted in a wounding-up manner. Then, a downward winding-off force due to the self-weights of the wheel support member 21 and the spare wheel thereon, and the like act on the left end of the suspending member 8. A winding-off moment acts on the winding drum 6 and the internal gear 7 as one body. The right side projection 14 of the rotation restricting plate 11 abuts on the rotation restricting pin 15 serving also as the safety pin. In this state, the winding drum 6 and the internal gear 7 are not rotated reversely unless the main shaft 3 is rotated reversely or unless the rotation restricting pin 15 serving also as the safety pin is broken. When the main shaft 3 is rotated reversely, rotated to wind off, the winding drum 6 is rotated reversely, the suspending member 8 is wound off, and the wheel support member 21 and the spare wheel thereon are lowered.

The winding device 1 is mounted at a rear lower part of a car body V of a passenger car, as shown in FIG. 5, using the bolt holes 19 of the case 2. A spare wheel T on the wheel support member 21 is wound up and held on a rear lower side of the car body V. In this state of holding the spare wheel, if car collision or the like applies large force to the wheel support member 21 and the spare wheel T thereon, and the winding-off force acting on the wheel support member 21 side of the suspending member 8 becomes equal to or more than a preset value that is larger than the winding-off force in normal use, the rotation restricting pin 15 serving also as the safety pin is broken at the root portion 17 that is the breakage location. Then, the winding drum 6 is rotated reversely. The suspending member 8 is wound off. The breakage of the wheel support member 21 side, i.e., the left end side of the suspending member 8 is prevented. When the rotation restricting pin 15 serving also as the safety pin is broken at the root portion 17 and the projecting pin portion 16 is broken off, the winding drum 6 can be rotated reversely by one turn or more.

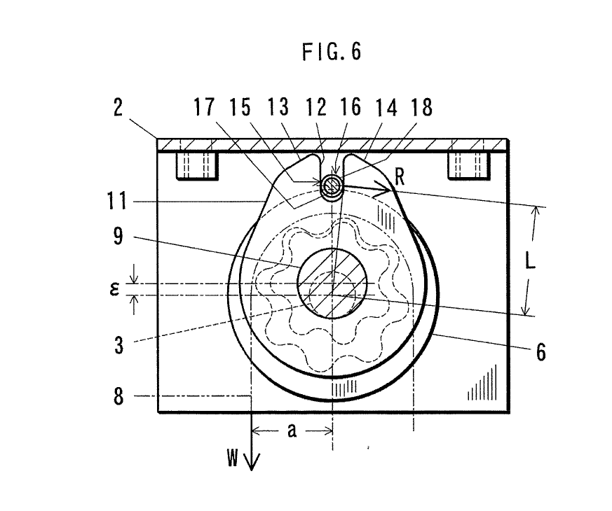

As shown in FIG. 6, if a winding-off force W is applied to the left end side of the suspending member 8, a counterclockwise winding-off moment W·a acts on the winding drum 6, where “a” is a distance between the winding-off force W and the center axis of the main shaft 3. At this time, a reaction force R generated at a contact point between the right side projection 14 of the rotation restricting plate 11 and the frictional portion 18 of the rotation restricting pin 15 serving also as the safety pin causes a clockwise moment R·L in the rotation restricting plate 11, where “L” is a distance between the contact point and the center axis of the main shaft 3. The clockwise moment R·L by the reaction force R balances with the counterclockwise winding-off moment W·a.

Since the moment R·L by the reaction force R balances with the winding-off moment W·a, the reaction force R becomes larger as the arm length L decreases. The reaction force R becomes smaller as the arm length L increases. The reaction force R increases or decreases as the distance L between the contact point at which the reaction force R is generated and the center axis of the main shaft 3 varies. However, an eccentric distance E of the eccentric cam 9 from the main shaft 3 is much smaller than the distance L between the contact point at which the reaction force R is generated and the center axis of the main shaft 3. Therefore, the distance L between the contact point at which the reaction force R is generated and the center axis of the main shaft 3 change according to the eccentric direction, i.e., the center axis position of the eccentric cam 9, but the change amount is a much small amount. That is, the change amount is a negligible much small amount. The reaction force R that the right side projection 14 of the rotation restricting plate 11 receives from the frictional portion 18 of the rotation restricting pin 15 serving also as the safety pin becomes substantially constant value, irrespective of the eccentric direction or the position of the center axis of the eccentric cam 9, if the winding-off moment W·a acting on the winding drum 6 is the same. The reaction force R has the same magnitude as a force with which the right side projection 14 of the rotation restricting plate forces to break the root portion 17 of the rotation restricting pin 15 serving also as the safety pin. The force with which the right side projection 14 of the rotation restricting plate 11 forces to break the root portion 17 of the rotation restricting pin 15 serving also as the safety pin becomes substantially constant value, irrespective of the eccentric direction or the position of the center axis of the eccentric cam 9, if the winding-off moment W·a acting on the winding drum 6 is the same. The winding-off force W of the suspending member 8 for the root portion 17 of the rotation restricting pin 15 serving also as the safety pin to be broken is scarcely varied by the eccentric direction or the position of the center axis of the eccentric cam 9, and becomes substantially constant value.

### Second Embodiment

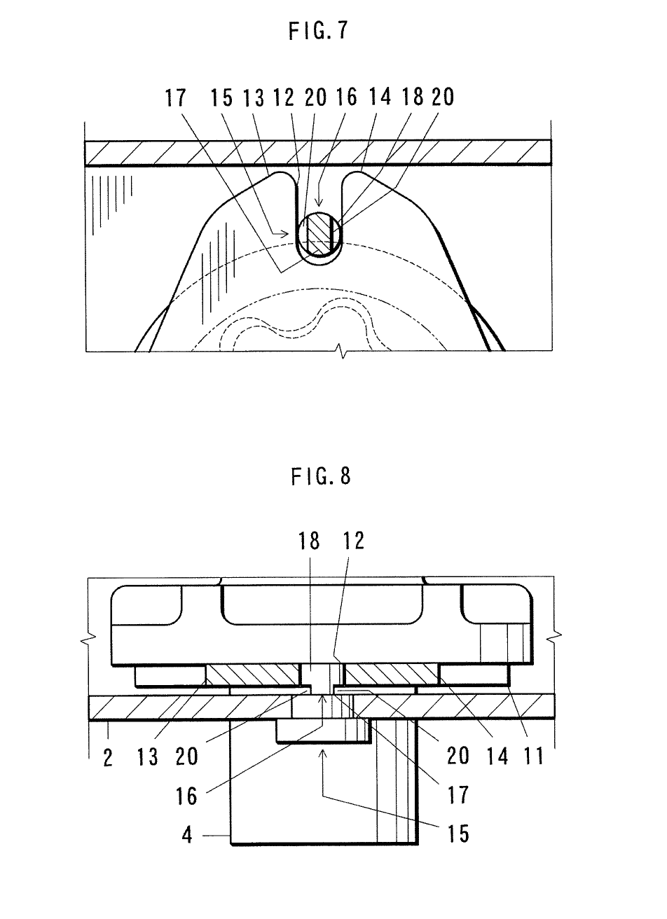

### See FIGS. 7 to 8

In this embodiment, in order to make the root portion 17 narrower or thinner than the tip end portion 18, as shown in FIG. 7 and FIG. 8, the projecting pin potion 16 of the rotation restricting pin 15 serving also as the safety pin is provided with grooves 20 on the left and right sides of the root portion 17. Each of the grooves 20 passes through vertically. The failure strength of the projecting pin portion 16 is adjusted by increasing or decreasing the thickness, i.e., a horizontal diameter of the root portion 17, or the depths of the grooves 20. The other structures are the same as in the first embodiment. The same parts as in the first embodiment are denoted by the same reference numerals as in the first embodiment.

### Modification of the Embodiments

In the above embodiments, the suspending member 8 and the winding drum 6 are the chain 8 and a chain wheel 6, but they are a wire rope and a wind-up drum for the rope.

### Advantages of the Embodiments

The failure strength-determining portion 17 of the root portion is not rubbed by the rotation restricting plate 11, and is not reduced in thickness by frictional wear. The failure strength is not lowered. When the winding-off force W applied to the suspending member 8 is smaller than a preset value, the rotation restricting pin 15 serving also as the safety pin is difficult to break. The wheel support member 21 and the spare wheel thereon are difficult to drop unexpectedly.

1. A suspending member breakage preventing mechanism in a spare wheel holding apparatus,
the spare wheel holding apparatus includes a wheel support member, which supports a spare wheel, and a winding device, which lifts up the wheel support member in a winding-up manner;
the winding device includes a case, a main shaft supported by the case in a bearing state, a winding drum rotatably fitted on the main shaft, a suspending member being wound on the winding drum and the suspending member being connected with the wheel support member, and a planetary gear mechanism having a large reduction ratio;
the planetary gear mechanism includes an internal gear provided concentrically to a side surface of the winding drum, an eccentric cam provided to the main shaft, an external gear rotatably fitted on the eccentric cam, the external gear being meshed with the internal gear, a rotation restricting plate provided to a side surface of the external gear, and a rotation restricting pin provided on the case, wherein the rotation restricting plate abuts on the rotation restricting pin to restrict axial rotation of the external gear, and when a winding-off force is applied to the suspending member, the rotation restricting plate abuts on the rotation restricting pin to stop reverse rotation of the winding drum;
the suspending member breakage preventing mechanism also uses the rotation restricting pin as a safety pin, the rotation restricting pin has a strength set so as to break when the winding-off force applied to the suspending member is larger than that in normal use, and when the rotation restricting pin is broken, the winding drum is rotated reversely and the suspending member is wound off;
the rotation restricting pin serving also as the safety pin has one end fixed to the case and the other end projecting into the case, the projecting pin portion is rubbed by contact with the rotation restricting plate, is subjected to a lateral force from the rotation restricting plate, and has a root portion set as a breakage location; and
the root portion is narrower than a tip end portion of the projecting pin portion, the tip end portion constitutes a frictional portion, which is rubbed by contact with the rotation restricting plate, and the root portion constitutes a frictionless failure strength-determining portion, which is not rubbed by the rotation restricting plate.

2. The suspending member breakage preventing mechanism according to claim 1, wherein
the root portion is concentric with and smaller in diameter than the tip end portion.

3. The suspending member breakage preventing mechanism according to claim 1, wherein
the projecting pin portion is disposed in parallel to the main shaft; and
the rotation restricting plate is provided with a groove extending in a direction from a circumferential surface toward the eccentric cam, the projecting pin portion is disposed in the groove, and a circumferential surface of the frictional portion comes in contact with a side face of the groove.

4. The suspending member breakage preventing mechanism according to claim 2, wherein
the projecting pin portion is disposed in parallel to the main shaft; and
the rotation restricting plate is provided with a groove extending in a direction from a circumferential surface toward the eccentric cam, the projecting pin portion is disposed in the groove, and a circumferential surface of the frictional portion comes in contact with a side face of the groove.

5. The suspending member breakage preventing mechanism according to claim 1, wherein
a distance between a contact point of the rotation restricting pin with the rotation restricting plate occurring when a winding-off force is applied to the suspending member and a rotation center axis of the main shaft becomes substantially constant value irrespective of the position of the eccentric cam.

6. The suspending member breakage preventing mechanism according to claim 2, wherein
a distance between a contact point of the rotation restricting pin with the rotation restricting plate occurring when a winding-off force is applied to the suspending member and a rotation center axis of the main shaft becomes substantially constant value irrespective of the position of the eccentric cam.

7. The suspending member breakage preventing mechanism according to claim 3, wherein
a distance between a contact point of the rotation restricting pin with the rotation restricting plate occurring when a winding-off force is applied to the suspending member and a rotation center axis of the main shaft becomes substantially constant value irrespective of the position of the eccentric cam.

8. The suspending member breakage preventing mechanism according to claim 1, wherein
the winding drum becomes able to make one or more reverse rotations when the projecting pin portion is broken off at the root portion.

9. The suspending member breakage preventing mechanism according to claim 2, wherein
the winding drum becomes able to make one or more reverse rotations when the projecting pin portion is broken off at the root portion.

10. The suspending member breakage preventing mechanism according to claim 3, wherein
the winding drum becomes able to make one or more reverse rotations when the projecting pin portion is broken off at the root portion.

11. The spare wheel holding apparatus according to claim 1, wherein
the case of the winding device is mounted on a car body of a motor vehicle, and the spare wheel supported on the wheel support member is lifted up in a winding-up manner and held to a lower side of the car body.

12. The spare wheel holding apparatus according to claim 2, wherein
the case of the winding device is mounted on a car body of a motor vehicle, and a spare wheel supported on the wheel support member is lifted up in a winding-up manner and held to a lower side of the car body.
